(19) United States
(12) Patent Application Publication
(10) Pub. No.: US 2003/0091299 A1
(43) Pub. Date: May 15, 2003

(54) Crimp-style connector for fiber reinforced premise cable

(76) Inventors: James R. Priest, Nashport, OH (US); Richard N. Lehman, Newark, OH (US); Thomas P. Hager, Westerville, OH (US)

Correspondence Address: OWENS CORNING, 2790 COLUMBUS ROAD, GRANVILLE, OH, 43023, US

(21) Appl. No.: 09/991,230

(22) Filed: Nov. 14, 2001

(51) Int. Cl. G02B 6/36

(52) U.S. Cl. 385/87; 385/81

(57) ABSTRACT

A premise cable having a plurality of inorganic fibers for protecting and suspending a plurality of optical fibers within a polymer jacket. The inorganic fibers, preferably fiberglass fibers, do not generate smoke or fire and thus offer an improvement over traditional polyaramid fibers used as reinforcement materials in premise cables. A sizing composition is applied to the inorganic fibers to prevent ribbonization of the inorganic fibers, thereby preventing attenuation of the optical fibers caused by such a ribbonization and also allowing a uniform distribution of fiberglass fibers around the optical fibers to further protect the optical fibers.

### TECHNICAL FIELD AND INDUSTRIAL APPLICABILITY OF THE INVENTION

The present invention relates generally to communication cables and more specifically to crimp style connectors for fiber reinforced premise cables.

### BACKGROUND OF THE INVENTION

Fiberoptic cables are commonly used to provide electronic communication in a wide variety of indoor and outdoor communication systems. One type of indoor fiberoptic cables, typically referred to as premise, plenum, or riser cables, are comprised of buffered optical fibers and loose reinforcement fibers contained within a fire resistant polymer jacket. The loose reinforcement fibers are typically coated with a coating that prevents abraiding during fiber generation.

The loose reinforcement fibers have many important functions within premise cables. First, the fibers provide some tensile strength during the installation process. Second, the fibers act as a cushion and space filler to protect and suspend the loose fiberoptic fibers within the polymer jacket. Third, the fibers prevent the adhesion of the fiberoptic fibers to the polymer jacket wall.

Connectors are used to allow premise cables to be plugged into devices that allow reception and transmission of optical signals. Two types of connectors that are typically used include glue connectors and crimp-type connectors.

Glue type connectors involve gluing the premise cable to the outlet such that the optical fiber contained within the premise cable is allowed to communicate with the intended device. Glue type connectors work well with glass fiber reinforcements, but the process for securing the premise cable to the intended device is slow and not easily automated.

Crimp-type connectors are the preferred method for coupling the premise cable to the intended device. In crimp-type connectors, the reinforcement fibers are bent over a base ring and secured there with a crimping ring. The optical fiber is secured through the crimping ring to an adapter of the intended with a ferrule.

One problem with crimp-type connectors is that the glass reinforcement fiber typically used in premise cables has a tendency to shear along the sharp edges of the base ring when coupled to a connector. This prevents the reinforcing fibers from bearing their full potential load.

It is therefore highly desirable to design a crimp-type connector system that prevents damage to the reinforcing fibers during the connection process.

### SUMMARY OF THE INVENTION

It is thus an object of the present invention to provide a method for designing a crimp style connector which will not damage the fibers intended to reinforce a premise cable and thus allowing them to bear their full potential load.

The method involves first calculating the critical bend radius of the fibers used to reinforce the premise cable using the fiber's diameter, elastic modulus, and ultimate tensile strength. The edges of the base ring are then manufactured to match or exceed this critical bending radius, thereby preventing the fibers from shearing when bent over the base ring. With this, reinforcing fibers can be fully loaded, resulting in stronger cable and allowing new materials to be used for cable reinforcement.

Other objects and advantages of the present invention will become apparent upon considering the following detailed description and appended claims, and upon reference to the accompanying drawings.

### BRIEF DESCRIPTION OF THE DRAWINGS

FIG. 1 is a perspective view of a premise cable according to a preferred embodiment of the present invention;

FIG. 2 is a close-up view of the reinforcement fiber of FIG. 1; and

FIG. 3 is a close-up view of the base ring of FIG. 1.

### DETAILED DESCRIPTION AND PREFERRED EMBODIMENTS OF THE INVENTION

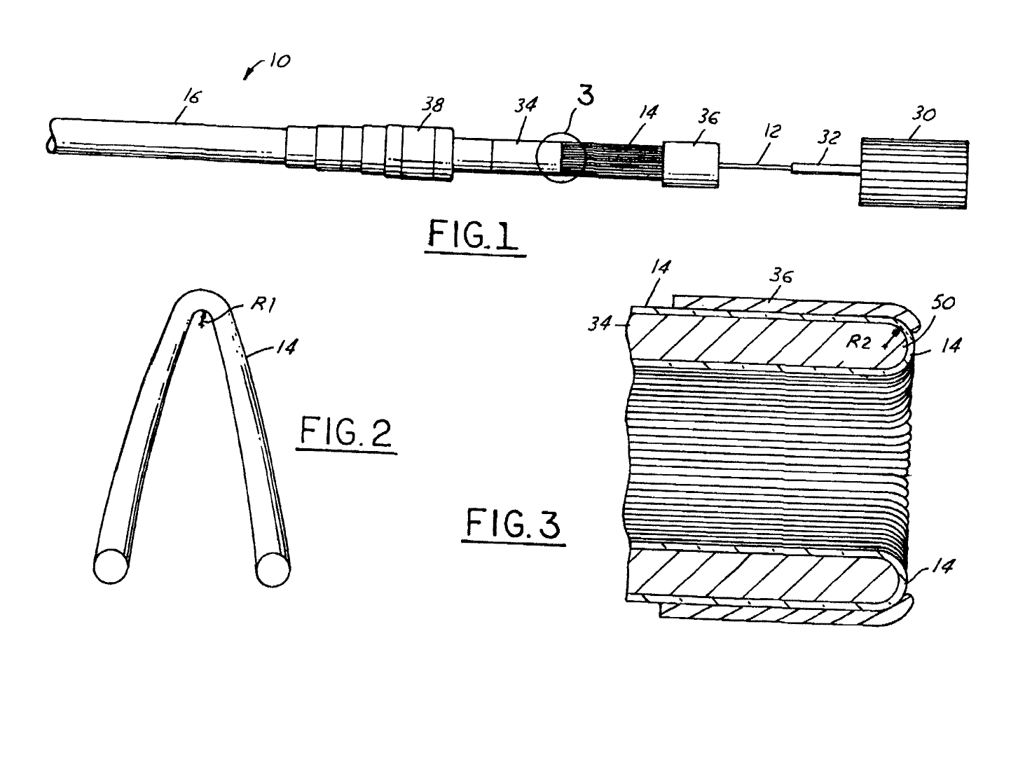

Referring now to FIGS. 1 and 2, a premise cable for use in indoor communications systems is shown generally as 10. The premise cable 10 consists essentially of a plurality of randomly placed, tight buffered optical fibers 12 and a plurality of loose fiberglass reinforcement fibers 14 contained within a fire resistant polymer jacket 16.

The optical fibers 12 are comprised of long, thin flexible fibers made of glass, plastic, or other transparent material that are well known in the art. Preferably, the fibers 12 are made of fused silica and are used as a pathway to transmit informational images in the form of light. The fibers 12 preferably are tight buffered and coated with a layer of acrylic coating.

The fire resistant polymer jacket 16 is similarly well known in the art, and may be comprised of a wide variety of polymers that are both water and fire resistant. Preferably, the jacket 16 is formed of a thin layer of polyvinyl chloride (PVC). In alternative embodiments, the jacket 16 may be formed of a thin layer of polyethylene having a non-halogenated fire retardant such as a metal hydrate. One example of a metal hydrate that may be used in alumina trihydrate.

The reinforcement fibers 14 are preferably single end E-type glass roving fibers, or type 30 roving fibers, that can be wound in a format that is commonly used to feed cable manufacturing equipment. However, other types of fiberglass may be used as well. These include Owens Corning Advantex® glass fibers, S-type glass, E-CR glass, AGY's ZenTron® high strength fibers, or any other type of glass as long as it meets the ultimate tensile strength, crush, impact, and fire resistance of the cable. The loose reinforcement fibers 14 have many important functions. First, the reinforcement fibers 14 provide some tensile strength during the installation process. Second, the reinforcement fibers 14 act as a cushion and space filler to protect and suspend the loose fiberoptic fibers 12 within the polymer jacket 16. Third, the fiberglass fibers prevent the adhesion of the fiberoptic fibers to the polymer jacket wall. The fibers 14 are typically protected with a sizing.

As seen in FIG. 1, the optical fibers 12 of the premise cable 10 are coupled to an adapter 30 using a ferrule 32. The reinforcement fibers 14 are twisted over a base ring 34 and secured with a crimping ring 36. A flexible sleeve 38 is then placed over the base ring 34 and crimping ring 36 to complete the coupling. The optical fibers 12 are then capable of receiving and transmitting optical signals when the adapter 30 is coupled to an appropriate device (not shown) in a method well known in the art.

As shown in FIG. 2, the reinforcement fiber 14 is shown at its critical bending point radius R1. To calculate the critical bending point radius R1, three things must be known about the reinforcement fiber 14. These include the fiber's 14 diameter D, the fiber's 14 elastic modulus (“E”), and the fiber's tensile strength (“T”). The formula for calculating the critical radius r is:

R1=ED/2T

The critical bending point radius R1 is defined the maximum radius of curvature allowable for the reinforcement fiber 14 before it tends to shear. As such, it is the maximum allowable bending radius that the reinforcement fibers 14 are allowed to have.

For example, for Owens Corning's PR600H E-type glass fiber, which has an elastic modulus of 10,500,000 psi (at room temperature), a tensile strength of 550,000 psi (at room temperature), and a diameter of 17 microns (0.00067 inches), the critical bending point radius R1 is calculated as about 162 microns (0.006395 inches). Similarly, for Owens Corning's PR735H fiber, which has a fiber diameter of 13 microns (0.00051 inches) and the same elastic modulus and tensile strength, the critical bending point radius R1 is calculated as about 124 microns(0.004868 inches).

Referring now to FIG. 3, a close-up view of the base ring 34 is shown as having a leading edge 50 that has a radius of curvature R2. This radius of curvature R2 is, at all times, greater than or equal to the critical bending point radius R1 of the reinforcement fiber 14. This ensures that the reinforcement fibers 14 can be fully loaded, resulting in a stronger premise cable 10.

The present invention offers a simple and efficient method for determining the proper base ring to be used to maximize the load bearing capabilities of the premise cable 10 regardless of the type of reinforcing fibers 14 used. This in turn allows many alternatives concerning reinforcement fiber 14 choice based upon the conditions in which the premise cable 10 will be used. For example, where load bearing is not a vital concern, fibers having lower elastic modulus or lower tensile strength may be used, as long as the radius of curvature R2 of the leading edge 50 is modified to accommodate this reinforcement fiber 14.

While the invention has been described in terms of preferred embodiments, it will be understood, of course, that the invention is not limited thereto since modifications may be made by those skilled in the art, particularly in light of the foregoing teachings.

What is claimed is:

1. A premise cable connector for aiding in coupling a premise cable to an adapter, wherein the premise cable has at least one optical fiber and at least one reinforcement fiber, the premise cable connector comprising:
a crimp ring; and
a base ring having a leading edge, wherein the at least one reinforcement fiber is secured over said leading edge and underneath said crimp ring such that the radius of curvature of the at least one reinforcement fiber is less than or equal to a critical bending point radius of the at least one reinforcement fiber.

2. The premise cable connector of claim 1, wherein said critical bending point radius is a function of the diameter of said at least one reinforcement fiber, the elastic modulus of said as least one reinforcement fiber, and the tensile strength of said at least one reinforcement fiber.

3. The premise cable connector of claim 2, wherein said critical bending point radius is calculated by multiplying the diameter of said at least one reinforcement fiber by the elastic modulus of said at least one reinforcement fiber and dividing the result by two times the tensile strength of said at least one reinforcement fiber.

4. The premise cable connector of claim 1, wherein the radius of curvature of said leading edge of said base ring is greater than or equal to said critical bending point radius of the at least one reinforcement fiber.

5. The premise cable connector of claim 3, wherein the radius of curvature of said leading edge of said base ring is greater than or equal to said critical bending point radius of the at least one reinforcement fiber.

6. A method for coupling a premise cable having at least one reinforcing fiber and at least one optical fiber to an adapter using a crimp style connector without reducing the load bearing strength of the at least one reinforcement fibers, the method comprising the steps of:
calculating a critical bending point radius of the at least one reinforcement fiber;
selecting a base ring having a leading edge having a first radius of curvature, wherein said first radius of curvature is greater than or equal to said calculated critical bending point radius;
securing the at least one reinforcement fiber around a leading edge of said base ring; and
crimping a crimp ring over said base ring.

7. The method of claim 6, wherein the step of calculating a critical bending point radius of the at least one reinforcement fiber comprises the steps of:
determining the diameter of said at least one reinforcement fiber;
determining the tensile strength of said at least one reinforcement fiber;
determining the elastic modulus of said at least one reinforcement fiber; and
calculating a critical bending point radius of the at least one reinforcement fiber by multiplying the diameter of said at least one reinforcement fiber by the elastic modulus of said at least one reinforcement fiber and dividing the result by two times the tensile strength of said at least one reinforcement fiber.

8. A method for coupling a premise cable having at least one reinforcing fiber and at least one optical fiber to an adapter using a crimp style connector without reducing the load bearing strength of the at least one reinforcement fibers, the method comprising the steps of:
selecting a base ring having a leading edge having a first radius of curvature;
selecting a reinforcement fiber having a critical bending point radius that is less than or equal to said first radius of curvature;
securing the at least one reinforcement fiber around a leading edge of said base ring; and
crimping a crimp ring over said base ring.

9. The method of claim 8, wherein the steps of selecting a reinforcement fiber having a critical bending point radius that is less than or equal to said first radius of curvature and securing the at least one reinforcement fiber around a leading edge of said base ring comprises the steps of:
selecting at least one reinforcement fiber;
determining the diameter of said at least one reinforcement fiber;
determining the tensile strength of said at least one reinforcement fiber;
determining the elastic modulus of said at least one reinforcement fiber; and
calculating a critical bending point radius of the at least one reinforcement fiber by multiplying the diameter of said at least one reinforcement fiber by the elastic modulus of said at least one reinforcement fiber and dividing the result by two times the tensile strength of said at least one reinforcement fiber;
comparing said critical bending point radius to said first radius of curvature; and
securing the at least one reinforcement fiber around a leading edge of said base ring when said critical bending point radius is less than or equal to said first radius of curvature.
